(19) United States
(12) Patent Application Publication
(10) Pub. No.: US 2014/0340917 A1
(43) Pub. Date: Nov. 20, 2014

(54) Illuminated Brake Assembly and Wheel Well Accessory

(71) Applicant: David Harraghy, Clearwater, FL (US)

(72) Inventor: David Harraghy, Clearwater, FL (US)

(21) Appl. No.: 14/281,827

(22) Filed: May 19, 2014

Related U.S. Application Data
(60) Provisional application No. 61/824,432, filed on May 17, 2013.

(51) Int. Cl. B60Q 1/32

(52) U.S. Cl. CPC B60Q 1/326
USPC 362/500

(57) ABSTRACT

An accessory for the wheel-well of a vehicle that is equipped with a series of lights designed to illuminate the inner portion of the space that exists between the brake rotors and the rim of the wheel in a conventional automobile. A series of LED lights are configured to project light from a ring that lines the brake rotor and brake caliper of a vehicle's brake assembly. Light is preferably projected in a 180 degree radius from the ring, which illuminates the rim of the wheel assembly, a portion of the ground beneath the vehicle, and portions of the wheel-well.

### CONTINUITY

This application is a non-provisional application of provisional application No. 61/824,432, filed on May 17, 2013, and priority is claimed thereto.

### FIELD OF THE PRESENT INVENTION

The present invention relates to exterior automobile modification. More specifically, the present invention relates to exterior automotive lights, specifically those positioned on or around the wheel assembly or wheel-well of a vehicle. The present invention is designed to be placed in a position outside the circumference of the rotor and brake caliper assembly. The present invention preferably rounds around the exterior of the rotor and brake caliper of the disc brake assembly of a conventional wheel assembly.

### BACKGROUND OF THE PRESENT INVENTION

Owners of automobiles have often sought to customize their vehicles in order to make them unique or stand out in a crowd. Modifications in the form of after-market parts have been created for nearly every facet of an automobile's interior and exterior, from seat covers, replacement headlights, and custom exhaust systems, to carbon fiber engine hoods, chrome rims, and specialty racing tires. Some modifications are designed to give the vehicle a custom look, whereas others are geared towards performance enhancement. In either regard, customers purchase these products on their own in order to enhance the beauty or performance of their vehicles.

One of the most popular ways to customize a vehicle is to add or enhance the interior or exterior lighting beyond what is initially supplied by the manufacturer of the vehicle. For example, vehicle owners often exchange the dull glow of incandescent bulbs from the vehicle's interior dome or map light with a bright LED bulb or colored LED bulb. Similarly, vehicle owners are apt to replace the standard headlight bulbs and fixtures with enhanced, bright halogen bulbs to provide better lighting on dark roads.

In the past, vehicle owners would put neon lights underneath the frame or carriage of their vehicles, wired directly to the battery, in order to cast a fluorescent glow on the street below the vehicle, to provide a unique effect at night. While this is still practiced in some districts, many areas of the world have enacted legislation in order to ban this type of exterior vehicle lighting, citing that it can be distracting to other drivers. This is unfortunate, but thankfully others have crafted new and exciting ways to bring unique exterior lighting to conventional vehicles while remaining within the scope of regulations defined by local laws.

Many forms of exterior lights have been created to illuminate the wheel well of a conventional vehicle; however, some of these have been cited as being non-compliant of local laws and regulations in some counties and countries. Similarly, many of them employ unfocused light that often causes the custom lighting to illuminate portions of the road, tires, or wheel well that may be distracting to other drivers.

Thus, there exists a need for a new form of exterior vehicle wheel well lighting that is able to remain compliant in light of enacted legislation, remain relatively non-distracting to other drivers, and satisfy the vehicle owner's desire for custom vehicle exterior lighting.

U.S. Pat. No. 5,548,274A, issued on Aug. 20, 1996 by Jaime Suarez is for a ‘Strobe Light for a Vehicle Tire and Wheel.’ Suarez varies from the present invention in that it is designed to strobe and display graphics and messages within the tire or wheelwell, whereas the present invention is preferably designed to provide static illumination, and is not designed to display graphics or messages. Similarly, the present invention is mounted near the rotor assembly of the vehicle, whereas Suarez employs a different mounting technique.

U.S. Pat. No. 4,381,537A by Cary Gloodt and issued on Sep. 2, 2003 is for an ‘Illusionary Wheel Cover Structure.’ Gloodt teaches a ‘translucent disk wheel cover’ wherein ‘the lamps being turned on and off in a desired sequence to provide the illusion of movement such as of spokes of a wheel as viewed upon the wheel cover.’ Gloodt varies from the present invention in that the present invention is configured to be a single ring with a dimension similar to that of the rotor of the vehicle, rather than a large flat disk designed to approximate the diameter of the wheel of the vehicle itself. Likewise, the present invention is designed to preferably provide static illumination, rather than to blink or strobe in accordance with the speed of the wheel's rotation as Gloodt proposes.

U.S. Pat. No. 6,045,244A, published on Apr. 4, 2000 by Jerry Dixon is for an ‘Illuminated Rotating Object.’ Dixon teaches an ‘A rotating object such as a wheel, wheel cover, or hubcap includes a lighting arrangement in the form of a super-thin lighting element such as an electro-luminescent or photo-luminescent strip or panel. In the case of an electro-luminescent strip or panel, the power supply is positioned on the rotating object so as not to interfere with rotation of the object.’ Dixon is similar to the present invention in that it is designed to ‘extend around the perimeter of a wheel or brake drum, however it differs in that does not rotate with the wheel as it turns.

### SUMMARY OF THE PRESENT INVENTION

The present invention lighting apparatus preferably employing a ring, equipped with a series of preferably L.E.D (Light Emitting Diode) lights that are designed to project light within the space found to exist between a tire rim and a tire brake assembly of a conventional vehicle. It is envisioned that the present invention is capable of projecting any color of light within a 180 degree radius from the bulbs, and that light may be cast on to the floor beneath the vehicle, as well as to the wheel well of a conventional vehicle.

The present invention preferably encompasses the outer circumference or edge of a conventional automobile rotor. The present invention is preferably held in position via a series of external mounts designed to create a buffer between the rotor and the present invention, in order to prevent the present invention from overheating due to the heat absorbed by the rotor during the process of braking.

The present invention is preferably equipped with numerous LED bulbs placed along the exterior ridge of the ring of the present invention. The LED bulbs are configured to project light within a span of approximately 180 degrees. The 180 degrees of projection is configured to cast light on the wheel/rim assembly of the wheel well, on to the pavement below the vehicle, as well as out, through gaps found to exist within the metal of many conventional metallic rims. It is envisioned that the LED bulbs may be embedded within a circuit-based strip of bulbs in order to facilitate installation of the LED bulbs onto the ring of the present invention, as well as to provide greater durability of the present invention when it is subjected to bumps and debris from the road surface.

At least one mount holds the ring of the present invention in place via conventional screws. The present invention preferably is held in place approximately 1 centimeter above the rotor of the brake assembly. The ring of the present invention is preferably designed to encompass the brake caliper assembly as well as the rotor along the vertical axis of the rotor itself, such that it appears as a stripe or strip of metal running around the circumference of the rotor and brake caliper.

The LED bulbs embedded within the ring of the present invention are configured to be oriented towards the wheel of the vehicle, and are capable of casting 180 degrees of light within the wheel well. In this configuration, the rim of the wheel itself is oriented at the center of the range of the 180 degrees of illumination, at approximately 90 degrees.

### BRIEF DESCRIPTION OF THE DRAWINGS

FIG. 1 displays the ring of the present invention when not mounted to a vehicle.

FIG. 2 is a diagram showing the preferred format for the wiring of the present invention.

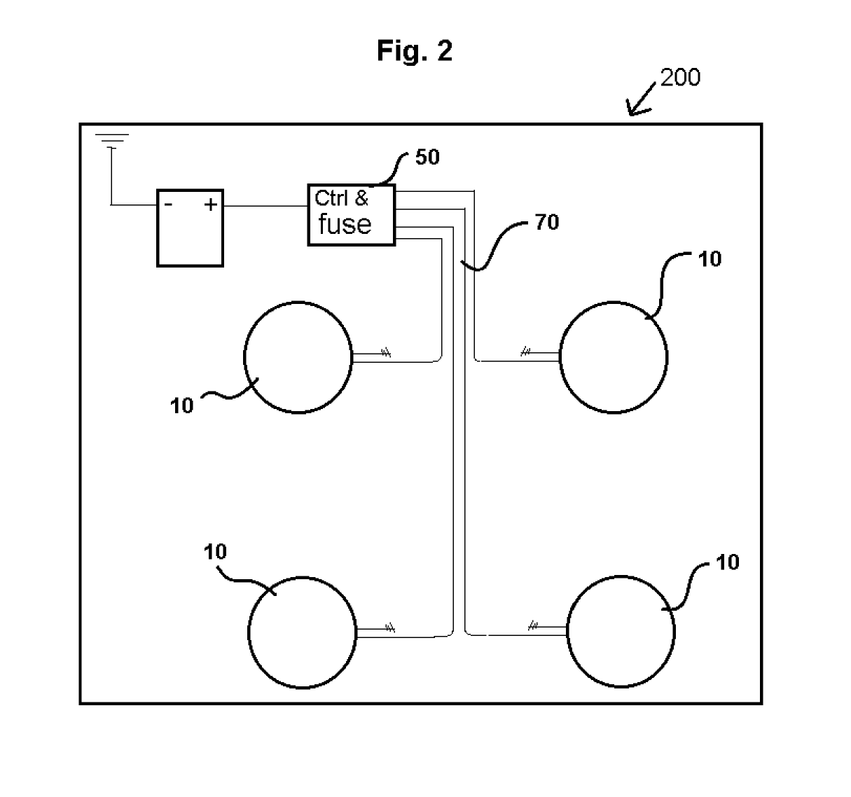

FIG. 3 shows the present invention from the side.

FIG. 4 shows an embodiment of the remote of the present invention.

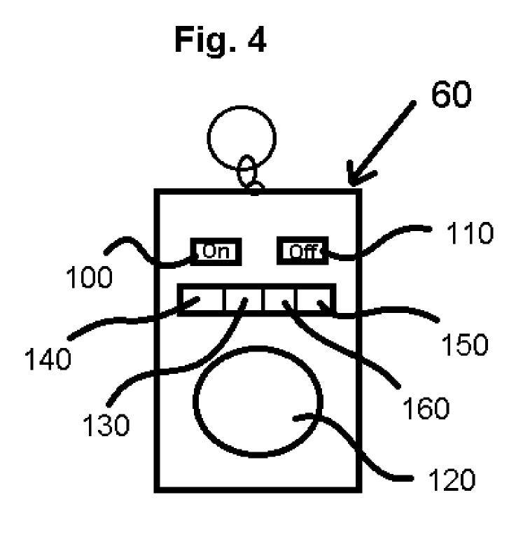

FIG. 5 exhibits a frontal view of the installation kit of the present invention.

### DETAILED DESCRIPTION OF THE PREFERRED EMBODIMENT

The present invention is an illumination system for the wheel-well area of a vehicle. More specifically, the present invention is designed to illuminate within the space found between the brake and rotor assembly of a vehicle and the rim and wheel assembly of the vehicle. Illumination is preferably provided via a ring (10) equipped with a series of LED lights (20), preferably placed equidistant from each other along the circumference of the ring. The LED lights (20) of the ring are preferably powered via direct current (DC) power supplied from the conventional 12 volt battery found in most contemporary vehicles. The ring (10) is preferably designed to be custom-sized according to the specific dimensions of the rotors of the vehicle it is to be installed on.

The ring (10) of the present invention is preferably composed of a soft or semi-malleable metal, in order to facilitate the casting of the ring (10), the installation of the ring (10) on to the vehicle, as well as the placement of the LED lights (20) onto the exterior surface of the ring (10). It is envisioned that the LED lights (20) of the present invention would preferably be contained within a LED light strip, which conventionally includes parallel wiring within a plastic or polycarbonate flexible casing, similar to that of a clear resin. However, in alternate embodiments of the present invention, the LED lights (20) may be directly embedded within the structure of the ring (10).

At least one mount (30) holds the ring (10) of the present invention in place, preferably via conventional screws (40). The preferred embodiment of the present invention preferably employs a total of five mounts (30) which are aligned similarly to spokes approaching the radius of the ring (10). However, installation of the present invention onto certain vehicles may require the use of only three mounts (30) in the event that certain hardware components of the vehicle interfere with the ideal installation of the present invention. The mounts (30) are preferably riveted to the ring (10) of the present invention. In turn, the mounts (30) are then preferably connected to the rear of the dust guard of the brake rotor assembly, helping to ensure that the ring (10) of the present invention does not become warped by excessive heat. The mounts (30) are preferably affixed to the dust guard with conventional nuts and bolts. It is envisioned that a single nut and bolt would be employed on each mount (30), ensuring uniform and stable placement of the present invention. The ring (10) of the present invention is preferably constructed out of aluminum or an aluminum alloy in order to help withstand the heat generated by the friction of the brake pads against the brake rotors. Likewise, the aluminum provides for the ring (10) of the present invention to be slightly flexible in order to accommodate irregular brake assemblies that may be larger or smaller than conventional assemblies

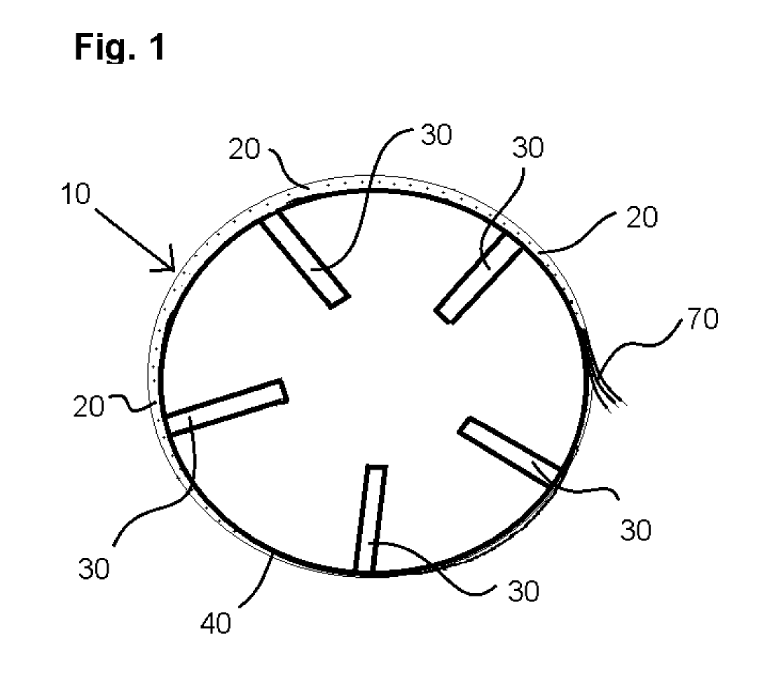

The present invention preferably is held in place approximately 1 centimeter above the rotor and brake caliper of the brake assembly, as seen in FIG. 1, in order to remain relatively unaffected by the heat transfer experienced by the rotor when the brakes of the vehicle are applied. However, it is envisioned that the ring (10) of the present invention could be held in place at a greater distance from the brake assembly if an alternate mount (30) were to be employed. The ring (10) of the present invention is preferably designed to encompass the brake caliper assembly as well as the rotor along the vertical axis of the rotor itself, such that it appears as a stripe or strip of metal running around the circumference of the rotor and extending to encompass the brake caliper. The ring (10) of the present invention is preferably unitary, but may be equipped with a seam.

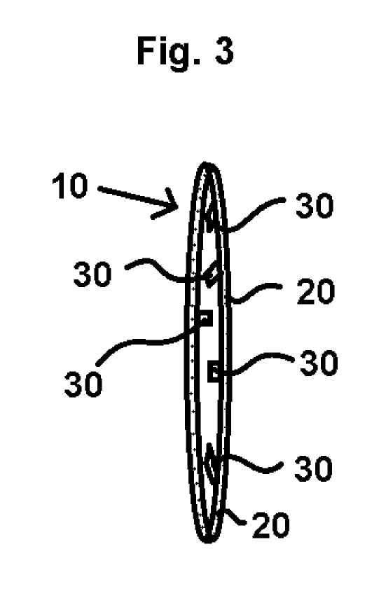

The LED lights (20) of the present invention are preferably configured to cast a light in a 180 degree radius, as seen in FIG. 3. The LED lights (20) are oriented such that they are in plane with the vertical brake rotor of the vehicle, and directed toward the corresponding tire and rim assembly of the vehicle. Therefore, the tire and rim assembly is preferably located at approximately 90 degrees within the LED lights' (20) 180 degree illuminating radius. The 180 degree radius from the LED lights (20) is therefore configured to cast light to the ground directly below the brake caliper, to the rim of the wheel, and to portions of the wheel-well. It is envisioned that, as the tire and rim assembly of the wheel revolve during travel, light projected from the LED lights (20) is reflected and refracted off of the chrome or other metallic composition of the rims of the wheels, causing portions of the rim to become illuminated via the reflected light. Similarly, light reflected off of the rim of the wheel may cast light in a wide number of directions according to the shape and structure of the rim itself.

The LED lights (20) of the present invention are preferably powered directly via the 12 volt DC power supplied by the battery of the vehicle. Conventional wiring is preferably employed in order to convey electric current to the LED lights (20). It is envisioned that a conventional switch (50) may be placed within the circuit, in order to provide control of the LED lights (20) of the present invention to the driver of the vehicle from within the cabin of the vehicle. Likewise, the switch (50) may be any of a wide variety of conventional switches, and may also be configured to be activated via a wireless receiver, or wired to turn on in conjunction with the factory-installed headlight switch of the vehicle. The switch (50) preferably interfaces with the wireless receiver via a set of wires (70) are preferably available on the exterior of the ring (10) in order to carry power to the present invention from the battery of the vehicle, or another power source. Similarly, the wires (70) carry the commands from the switch (50) and/or remote (60) to the LED lights (20) on the ring (10) of the present invention.

In the preferred embodiment of the present invention, the ring (10) is preferably pre-sized according to generic measurements of the brake caliper combined with the brake rotor of a vehicle. For example, the ring (10), LED lights (20), mount (30), and mounting materials such as screws, nuts, and bolts are prepackaged together in a kit that is specifically designed (sized) for specific vehicles. The prepackaged materials are preferably labeled according to the vehicle wheel assembly of the specific vehicle manufacturer and model. Similarly, a universal kit could be prepackaged with materials sized and designed to fit most makes and models of vehicles.

Alternate embodiments of the present invention are preferably equipped with a wireless activation switch which provides for the wireless activation of the illumination of the LED lights (20) around the ring (10) of the present invention. This alternate embodiment of the present invention minimizes the required installation time and minimizes the amount of wiring required to be installed in order for the present invention to function. For example, the implementation of a wireless activation switch eliminates the need for wires to be run from the cabin of the vehicle to the wheelwell area where the ring (10) of the present invention is preferably installed. The wireless switch is preferably battery powered, and may be embodied in a wireless key fob switch, referred to as a remote (60), similar to those used for conventional remote start systems or keyless entry systems. Alternately, the wireless activation switch may simply employ an RF signal or a conventional Bluetooth signal. The RF receiver or Bluetooth receiver could be powered by a small battery on the ring (10) in order to eliminate additional wiring to the battery of the vehicle.

Likewise, if conventional Bluetooth or WiFi technology is implemented into an embodiment of the present invention, mobile devices with integrated Bluetooth radio stacks such as smart phones, iPod's, and tablets could activate the present invention remotely when within range of the present invention. A custom application would preferably be executed on the mobile device that would enable communication between the mobile device and the Bluetooth radio on or near the ring (10) of the present invention. Conversely, through mobile device integration, the present invention could be configured to be activated via the internet, provided that the mobile device is proximal to the present invention, and that the mobile device is capable of serving an internet connection. The mobile device application would preferably provide additional features beyond simple activation and deactivation of the LED lights (20), such as changing the color of the light illuminated from the ring (10), varying the intensity of the LED lights (20), and selecting the rate at which the LED lights (20) will cycle through each color (frequency of the cycle). Similarly, color selection of the LED lights (20) of the present invention could be implemented into the activation switch, be it wired or wireless, which would be preferably installed on the dash of the vehicle or in another easily accessible location.

Another aspect critical to the efficacy of the present invention is a weather seal. In order for the electrical components of the present invention to function properly, the threat of short-circuiting caused by water must be eliminated. Therefore, the present invention preferably employs a silicone seal enclosing the wires and LED lights (20) of the present invention, keeping them dry, and ensuring they are not exposed to dirt and water that may be splashed onto the present invention from the road as the vehicle is in motion.

In alternate embodiments of the present invention, it is envisioned that the ring (10) of the present invention may be able to be custom-sized and configured by the end-user. For example, the semi-malleable metal that the ring (10) is preferably composed of could arrive to the end-user or installer as a long strip of metal with the LED lights (20) pre-attached. In this embodiment, the strip of metal would be measured and cut to size according to the circumference of the end-user's rotor and brake caliper assembly structure, and then bent into the shape of the ring (10) of the present invention by the end-user prior to installation. The two ends of the strip would then be secured together via a conventional nut, bolt, screw, or other conventional means, such as an adhesive, in order to form the ring (10) of the present invention.

Additionally, in other alternate embodiments of the present invention, the LED lights (20) may be configured to oscillate. Likewise, it should be understood that the LED lights (20) of the present invention may be configured to emit light in any of the colors of the visible spectrum. The colors emitted by the LED lights (20) of the present invention are configured to be easily selected by the user via the remote (60). The remote (60) is preferably equipped with an on button (100), and off button (110), a color selector button (120), a strobe button (130), a frequency selector button (140), a random button (150), and a connect button (160). The color selector button (120) may be shaped as a color selection wheel in order to facilitate rapid selection of a desired color. The connect button (160) is preferably used in the event that the remote (60) needs to be paired again to the wireless receiver and switch (50). It is envisioned that a standard, non remotely operated control may be employed to operate the present invention from within the vehicle. It is similarly envisioned that a control module may be employed in order to facilitate connection of the present invention to a smartphone via a secure Bluetooth connection.

While it is envisioned that, in the preferred embodiment of the present invention, the ring (10) of the present invention encompasses the brake caliper and the brake rotor of a vehicle's brake assembly, as seen in FIG. 1, forming a enclosed circle, it is envisioned that, in alternate embodiments of the present invention, the metallic strip composing the ring (10) may be configured to more accurately outline the brake caliper. In this embodiment, a semi-circle is formed to surround the portion of the brake rotor that is not in communication with the brake pad and brake caliper assembly. This enables the ring (10) of the present invention to more accurately remain proximal to the rotor of the brake assembly. The remainder of the metallic strip is then bent to accurately outline the shape of the brake caliper.

Likewise, while the present invention is configured to be installed on vehicles employing disc brakes, alternate embodiments of the present invention could be configured to be installed on wheel assemblies that employ conventional drum brakes. In this alternate embodiment of the present invention, the ring (10) is preferably designed to encompass the entirety of the drum brake. Given that the drum brake is not as prone to extreme heat, the ring (10) may be mounted directly to the drum brake assembly itself via an adhesive.

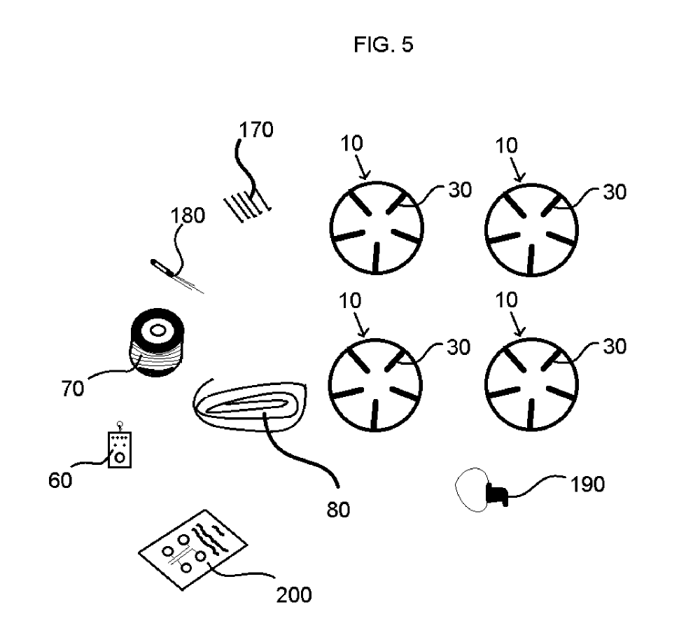

All embodiments of the present invention are preferably designed to be easily installed by the end consumer, or by a mechanic at a car service station. For those consumers wishing to save time and money, the present invention may be bundled with an easy installation kit as seen in FIG. 5. The installation kit includes four instances of the ring (10), each equipped with mounts (30). An assortment of zip ties (170) are included in the installation kit to facilitate rapid and secure installation of the present invention onto the brake assembly area of the vehicle. Additionally, a spool of wire (70), which is preferably RGB wire, is also included. The remote (60), an inline fuse (190), and an LED indicator light (180) for use within the cabin of the vehicle are preferably included in the installation kit, along with a wiring diagram (200) which preferably comes complete with installation instructions. A coil of Red/Black wire (80), preferably about 5 feet long, is included as well. The at least one LED light (20) are preferably arranged in conventional LED light strips. The LED light strips are preferably sealed with a polymer such as a clear acrylic, plastic, or silicone based material. The LED light strips are configured to be waterproof, and preferably carry a waterproof rating of IP-68 or higher. Conventionally, IP-65 is employed for LED lighting on houses and other conventional uses; however, it is preferred that the LED lights (20) encased within the LED light strips of the present invention employ an IP-68 grade due to the superior strength and durability of the IP-68 rating versus other, weaker ratings such as IP-65. The present invention is properly equipped to handle a user driving in rain and through a carwash without damaging the present invention.

Having illustrated the present invention, it should be understood that various adjustments and versions might be implemented without venturing away from the essence of the present invention. Further, it should be understood that the present invention is not solely limited to the invention as described in the embodiments above, but further comprises any and all embodiments within the scope of this application.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

I claim:

1. An accessory for the wheel-well area of a vehicle comprising:
a power supply;
at least one LED light;
at least one ring;
a rim, circumscribing said ring;
at least one wire;
a control;
at least one mounting bracket;
wherein said at least one LED light circumscribes said ring;
wherein said at least one mounting bracket is in communication with said ring; and
wherein said at least one LED light is configured to cast light in the following orientations: toward center line of vehicle, within the wheel, and outward from the vehicle.

2. The accessory for the wheel-well area of a vehicle of claim 1, wherein said control is remotely operated.

3. The accessory for the wheel-well area of a vehicle of claim 2, further comprising a wireless receiver, said wireless receiver configured to interface with said control.

4. The accessory for the wheel-well area of a vehicle of claim 1, further comprising a light controller, wherein said light controller is configured to interface with a mobile device.

5. The accessory for the wheel-well area of a vehicle of claim 2, wherein said at least one mounting bracket is affixed to the wheel-well area of the vehicle.

6. The accessory for the wheel-well area of a vehicle of claim 5, wherein said ring is metallic.

7. An accessory for a brake-assembly area of a vehicle comprising:
a power supply;
at least one LED light;
a light controller;
at least one wire;
at least one wireless receiver;
a control, wherein said control is remotely operated;
at least one mounting bracket, said at least one mounting bracket configured to mount to the brake-assembly area of the vehicle;
a ring, wherein said ring has a rim;
wherein said at least one LED light circumscribes said rim of said ring;
wherein said at least one mounting bracket is in communication with said ring;
wherein said at least one LED light is configured to cast light in 180 degrees atop said rim of said ring;
wherein said at least one wire conveys power from said power supply to said light controller, to said wireless receiver, and to said at least one LED light.

8. The accessory for the brake assembly area of a vehicle of claim 7, wherein said at least one mounting bracket is affixed to the wheel-well area of the vehicle.

9. The accessory for the brake assembly area of a vehicle of claim 8, wherein said at least one LED light is configured to be uncovered for 180 degrees.

10. The accessory for the brake assembly area of a vehicle of claim 9, wherein said light controller is configured to interface with a mobile device.

11. A smart-phone controlled light accessory for a wheel-well area of a vehicle comprising:
at least one LED light;
a ring, wherein said ring has a rim;
a light controller, said light controller equipped with a Bluetooth radio;
a power source;
at least one wire;
at least one mounting bracket;
a control mechanism, wherein said control mechanism is configured to interface with the smart-phone;
wherein said at least one mounting bracket is in communication with said ring;
wherein said at least one mounting bracket is in communication with the wheel-well area of the vehicle;
wherein said power source is in communication with said at least one LED light and said light controller via said at least one wire;
wherein said at least one LED light is configured to cast light in 180 degrees; and
wherein said at least one LED light is configured to be visible from the center axis of the vehicle, within the wheel of the wheel-well of the vehicle, and from the sides of the vehicle.

12. The accessory for the brake assembly area of a vehicle of claim 11, wherein said at least one LED light is configured to be uncovered for 180 degrees.
